(19) United States
(12) Patent Application Publication
(10) Pub. No.: US 2017/0097814 A1
(43) Pub. Date: Apr. 6, 2017

(54) AUTOMATIC MULTI-PLATFORM MOBILE APPLICATION DEVELOPMENT

(71) Applicant: Microsoft Technology Licensing, LLC, Redmond, WA (US)

(72) Inventors: Anders Gade Nørskov, Copenhagen (DK); Mike Borg Cardona, Skodsborg (DK); Michael Helligsø Svinth, Taastrup (DK); Lukasz Zoglowek, Copenhagen (DK); Adriana Horina Serbanescu Dale, Birkerod (DK); Vincent Francois Nicolas, Copenhagen (DK)

(21) Appl. No.: 14/874,192

(22) Filed: Oct. 2, 2015

(51) Int. Cl. G06F 9/45; G06F 17/30

(52) U.S. Cl. CPC G06F 8/447; G06F 17/30896

(57) ABSTRACT

A mobile application development system includes a processor that is a functional component of the mobile application development system and that is configured to execute programmatic steps. A build component is configured to receive web application source code and generate a mobile web application for a targeted mobile application platform. A build director component is configured to receive the web application source code and customization information and direct the build component to generate a plurality of mobile web applications each targeting a different mobile application platform, using the same web application source code and the customization information.

### BACKGROUND

Mobile devices are ubiquitous and allow users to interact with a wide variety of information sources. Such sources range from news outlets on social media to confidential enterprise resources. Typically, a mobile application is generated by a developer who targets a specific mobile device platform and creates an application, or “app”, that is compiled and provided to a mobile application marketplace for consumption by users.

Mobile application development was traditionally performed in the native language of the mobile device and/or platform for which it would ultimately be deployed. In such instance, the mobile application would generally be written in the native language of the mobile device platform including specific calls to hardware or system resources that were specific to the platform, and then ultimately compiled and provided to the mobile application marketplace. As can be appreciated, if developers of mobile applications wished to provide such applications on all available mobile application platforms, significant work would be required to essentially code each application in the native language of the targeted platform.

More recently, mobile application developers have been provided with the ability to code or otherwise generate mobile applications using standardized web technologies such as HTML, CSS, and JavaScript. When such “web” applications are developed, they can easily be targeted to different platforms by using native application wrappers or shims on each such specific platform that accepts standardized API calls from the web applications. One example of such a mobile development framework is known as Apache Cordova and is supported by the Apache Software Foundation (ASF).

The discussion above is merely provided for general background information and is not intended to be used as an aid in determining the scope of the claimed subject matter.

### SUMMARY

A mobile application development system includes a processor that is a functional component of the mobile application development system and that is configured to execute programmatic steps. A build component is configured to receive web application source code and generate a mobile web application for a targeted mobile application platform. A build director component is configured to receive the web application source code and customization information and direct the build component to generate a plurality of mobile web applications each targeting a different mobile application platform, using the same web application source code and the customization information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a computing environment in which embodiments described herein are particularly useful.

FIG. 2 is a diagrammatic view of a mobile application building system with which embodiments described herein are particularly useful.

FIG. 3A is a diagrammatic view of a mobile application build environment in accordance with an embodiment described herein.

FIG. 3B is a diagrammatic view of a build director generating a mobile application in accordance with an embodiment described herein.

FIG. 3C is a diagrammatic view of customization information for mobile application builds in accordance with an embodiment described herein.

FIG. 4 is a diagrammatic view of another mobile application environment in which embodiments described herein can be practiced.

FIG. 5 is a flow diagram of a method for developing a mobile application in accordance with one embodiment.

FIG. 6 is a simplified block diagram of one illustrative embodiment of a handheld or mobile computing device that can be used as a user's or client's hand held device, in which parts the present system can be deployed.

FIG. 7 shows one embodiment in which device the mobile device is a tablet computer.

FIG. 8 provides an additional example of a mobile devices that can be used, although others can be used as well.

FIG. 9 illustrates one embodiment of a computing environment in which architecture 100, or parts of it, (for example) can be deployed.

### DETAILED DESCRIPTION

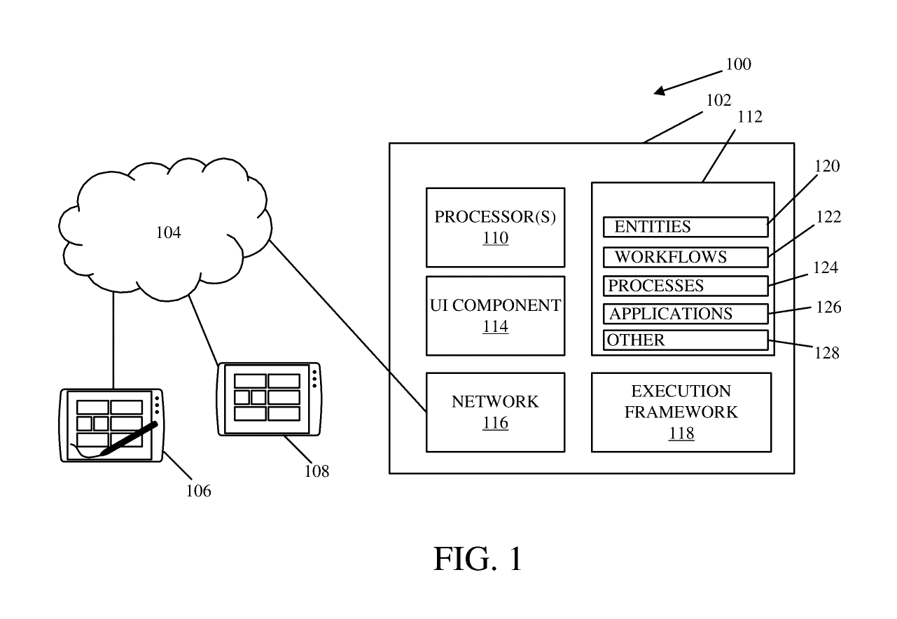

FIG. 1 is a diagrammatic view of a computing environment in which embodiments described herein are particularly useful. Environment 100 generally includes a data system, such as data system 102, coupled to a plurality of mobile devices 106, 108 via a communication network, such as wide area network 104. Computer system 102 includes processor(s) 110, data store 112, user interface component 114, network component 116, and application execution framework 118. Data store 112 may include one or more data storage structures that are configured to store any suitable data relative to the function of computer system 102. In one example, computer system 102 may be a business system, such as an enterprise resource planning (ERP) system, a customer relationship management (CRM) system, or a line-of-business (LOB) system, among others. In one embodiment, data store 112 may be configured to store entities 120, workflows 122, processes 124, and applications 126, and any other suitable information 128. Entities component 120, in one embodiment, describes entities within system 102. For example, a customer entity describes and defines a customer. A vendor entity describes and defines a vendor. An inventory item entity describes and defines an item of inventory. The listing set forth above is provided as a non-limiting example of various entities that can be defined within system 102.

Workflows 122 and processes 124, in one example, operate on data entities 120 as well as other suitable records 128 within data store 112 to enable a user to perform his or her operations within system 102. In one example, user interface component 114, either by itself or under the control of other items within system 102, generates user interface displays on mobile devices 106, 108.

Applications 126 can be any suitable applications, such as applications that are configured to execute upon one or more of mobile devices 106, 108. Additionally, or alternatively, applications 126 may execute within execution framework 118 such that the result of such execution is provided via user interface component 114 to mobile devices 106, 108 via network connection 104.

System 102 may, in some embodiments, be of the type that is generally provided by a software vendor in an initial condition. Then, system 102 is customized, sometimes heavily so, by developers and/or other suitable personnel, for deployment in a particular implementation. While the initial condition of the software system may be generic to an entire product line (such as an ERP system), the implemented deployment will be specific to a customer's requirements. Accordingly, the process of customizing the system for deployment to an individual implementation can also include the specification of customer identification information, customizations, and branding information. In order to ensure that this identification and branding information is carried forth to the mobile applications that execute upon mobile devices 106, 108, it is also important that such mobile applications be generated or otherwise provided to have such end-user customization, identification, and branding information. While embodiments described herein will generally be described with respect to applicability to system 102, it is expressly contemplated that embodiments described herein are applicable to any multi-platform mobile application development for which at least some information, and/or appearance of the mobile application will vary for each mobile application platform developed while the behavior of the mobile application remains the same.

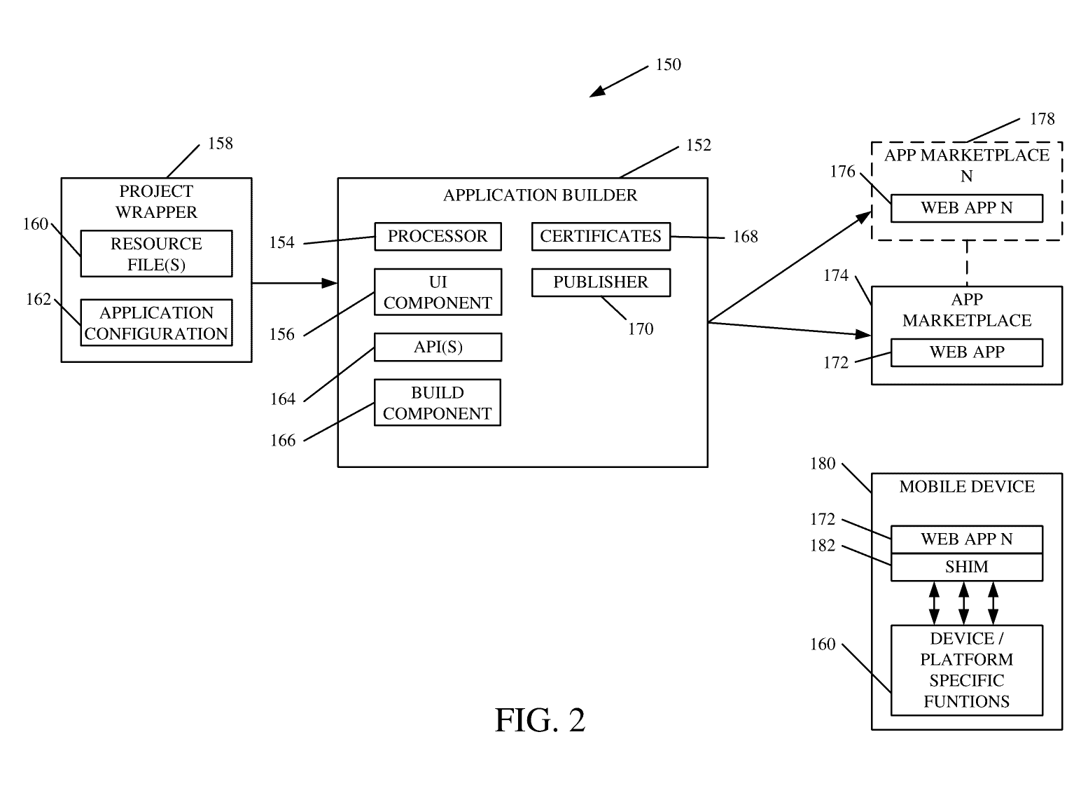

FIG. 2 is a diagrammatic view of a mobile application development system with which embodiments described herein are particularly useful. System 150 generally employs web application source code to generate mobile applications that are targeted to different mobile application platforms and/or devices. System 150 generally includes mobile application builder 152 that may be a computing system that is suitable configured to receive web application source code and generate web applications for mobile devices. In particular, application builder 152 may include one or more processors 154 that are functional components of system 152 and are configured to execute programmatic steps in order to effectuate one or more purposes or functions of mobile application builder 152. Application builder 152 may also include UI component 156 that is configured to generate a user interface for one or more users. Through this user interface, a user may specify web application source code information, such as web application source code 158. In one example, application builder 152 includes the Apache Cordova system. However, embodiments can be practiced where a different application development framework receives web application source code and generates a number of mobile applications targeted for different mobile application platforms.

Web application source code 158 is generally provided in the form of a project wrapper that includes or identifies one or more resource files 160 and application configuration information 162. These resource files and application configuration information generally describe a mobile application in terms of standardized web application technology. For example, the appearance of the application will generally be defined in terms of HTML and CSS. Additionally, the behavior of the web application will generally be defined in terms of JavaScript. All of these files and specifications, as well as any supporting files or configuration information, are stored within project wrapper 158. Project wrapper 158 is provided to application builder 152 either via UI component 156 or via application programming interfaces 164. In any event, build component 166 of application builder 152 is configured to employ processor 154 and any other suitable computing resources to generate a mobile application that is targeted to a particular mobile application platform. Examples of mobile application platforms include, without limitation, Windows Phone, available from Microsoft Corporation, of Redmond, Wash.; Android, available from Google Inc. of Mountain View, Calif.; iOS, available from Apple Computer Company of Cupertino, Calif.; Fire OS, available from Amazon.com, Inc. of Seattle, Wash.; HP WebOS, available from Hewlett-Packard, of Palo Alto, Calif.; BlackBerry OS, available from BlackBerry of Waterloo, Ontario; or others that are later developed or become available.

With each mobile application built by application builder 152, builder 152 may sign or otherwise certify the application using one or more certificates 168. Finally, the signed mobile application may be published using publisher component 170 of application builder 152. The published application is then stored or otherwise linked to its proper application marketplace. This is shown as built application 174 being provided within app marketplace 172. Additionally, the same web application N may be targeted to a different mobile platform and stored or otherwise associated with that platform's suitable marketplace. This is indicated at web application N 176 being stored within application marketplace N 178. Once the mobile application is associated or otherwise stored with its appropriate marketplace, a user of a mobile device, such as mobile device 180 may simply direct his or her mobile device to the suitable application marketplace for that mobile device and search for the web application. Upon identifying the web application, the mobile device 180 may install and store the web application. As shown in FIG. 2, web application 172 is stored within mobile device 180. As a web application, application 172 employs a native application wrapper or shim 182 in order to interface with platform and/or device specific resources. The interaction between web application 172 and shim 182 is in accordance with standardized application programming interfaces. Thus, the applications built by application builder 152 are relatively generic and the platform/device specific aspects are handled by the individual shims or native application wrappers that are present in each mobile device executing the web application. While such web applications may not execute as quickly as mobile applications tailored for a particular mobile platform using code native to that platform, the system shown in FIG. 2 allows applications to be created across virtually all available mobile platforms with relative ease.

While the mobile application development environment described above with respect to FIG. 2 is useful for providing identical web applications for a variety of mobile platforms, it is somewhat limited and cumbersome when the individual mobile applications may have different versions and/or different identities and branding information. In such cases, it is necessary to repeatedly create individual project wrappers 158 and generate associated mobile applications for each instance where a different identity and/or branding information is necessary for the mobile application. Moreover, the process is not as simple as creating a different brand and re-executing the compilation process. Instead, the current system essentially requires that the entire project be redone for each distinct mobile application that must have different visual appearances and/or branding. This increases development effort, generates an increase and duplication of code base, and results in higher maintenance and development costs.

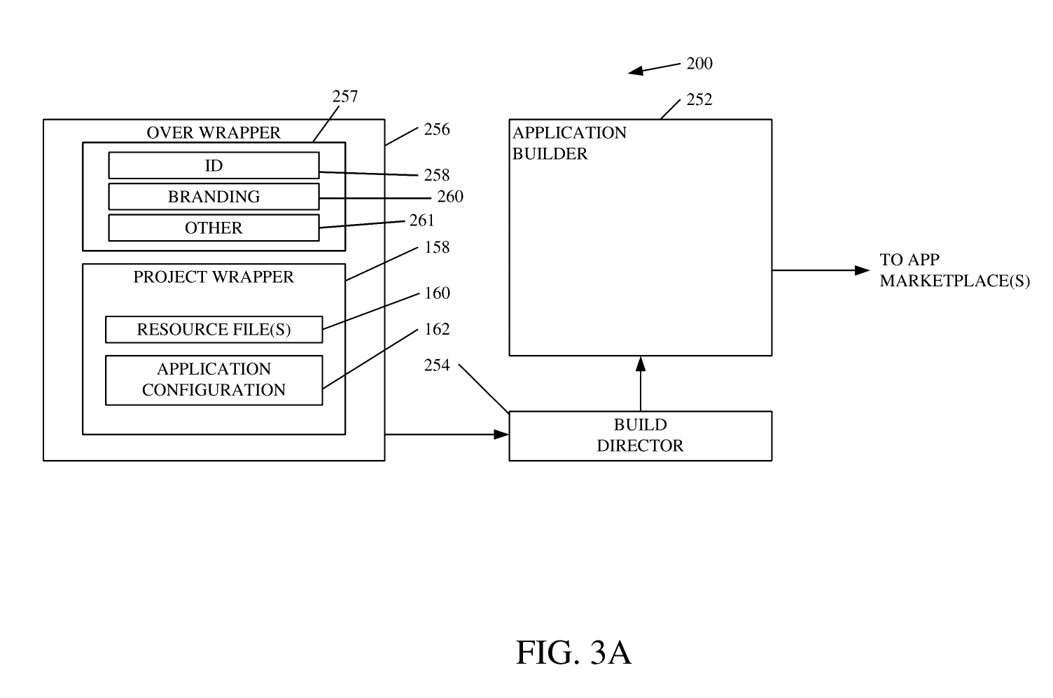

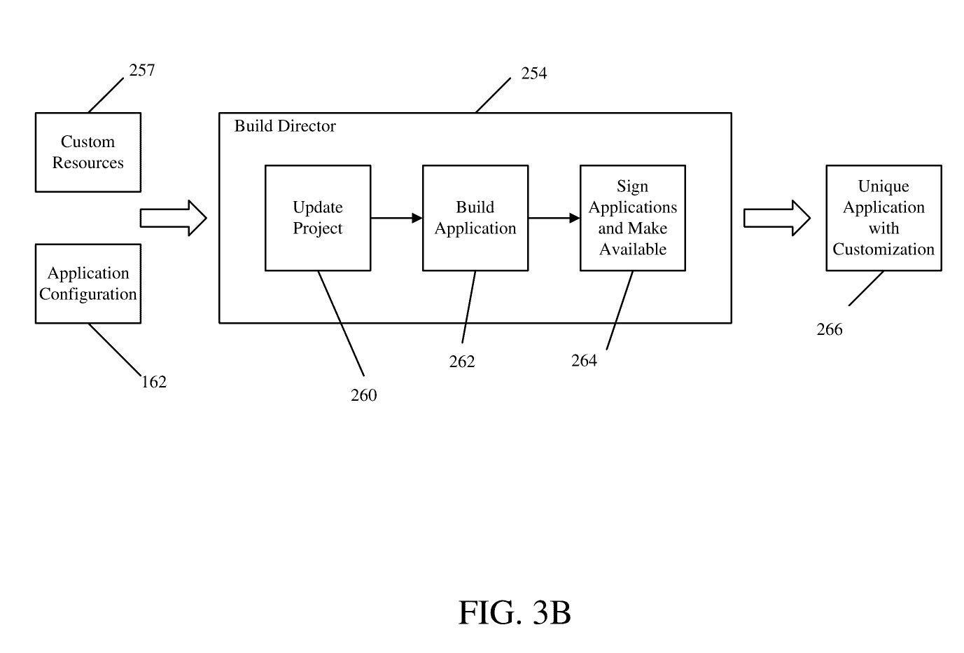

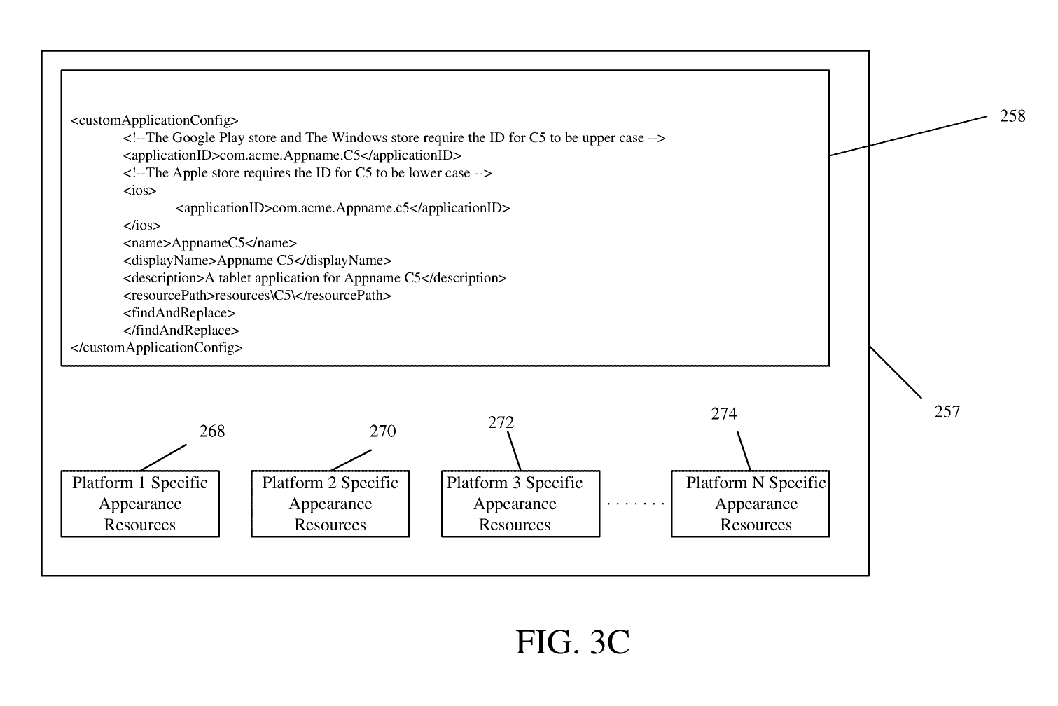

FIG. 3A is a diagrammatic view of a mobile application build environment in accordance with an embodiment described herein. Build environment 200 includes application builder 252 which may be the same as application builder 152. However, it is expressly contemplated that embodiments described herein can include additional features in comparison to application builder 152. Thus, a different reference number is used. For example, build director component 254 while shown separate from application builder 252 in FIG. 3A, could, in fact, be a component thereof. Environment 200 includes a project wrapper 158 that is the same as that described with respect to FIG. 2. Thus, project wrapper 158 may include various resource files 160 and application configuration information 162. However, as shown in FIG. 3A, an over-wrapper 256 is provided that essentially encapsulates project wrapper 158 as well as customization information 257. Customization information 257 can include any information or resources that define, in part or in whole, the appearance of a mobile application during execution of the mobile application after display of any applicable mobile application splashscreen. Customization information 257 can include identification information 258, branding information 260 and other information 261. Accordingly, over wrapper 256 not only includes web source code as defined in project wrapper 158, but also customization information 257. Such customization information can include any suitable identification, image files, logo, fonts, or other company or entity-specific information. However, a single web application source specification (in the form of HTML, CSS, and JavaScript, in one example) is used to generate multiple web application builds using application builder 252.

In order to facilitate such multiple operation, over wrapper 256 is provided to build director 254 that operates or is coupled to application builder 252. Build director 254 uses the information stored within over wrapper 256 in order to generate two or more build operations using application builder 252 with different information from customization information 257. In one embodiment, build director 254 performs a prepare operation in which identification information 258 and/or branding information 260 and/or other information 261 targeted to a particular mobile platform is propagated to the correct folders and locations within project wrapper 158. Then, build director 254 performs a compile operation that invokes application builder 252 on the project wrapper to create a mobile application with the correct identification and/or branding and/or other information. Subsequently, or in parallel, build director 254 may propagate different identification and/or branding information and/or other information to a second project wrapper 158 and again invoke application builder 252 on the second project wrapper to generate a second mobile application for a different mobile application platform with different identification and/or branding information and/or other information than the first application, but with substantially the same behavior as the first application. In this way, multiple web applications can be targeted for multiple mobile platforms where each web application on a respective mobile platform may have specific versions of the applications, and different identity and/or branding information, while still maintaining substantially the same behavior. Thus, unique mobile applications can be created and distributed through respective mobile application marketplaces each with their own name, description, icons, images and font resources from a single functional code base. The entity-specific application identity, branding resources, and other information is defined in fields 258, 260, and 261 respectively, and is used by build director 254 during the build process to update the relevant project files to reflect applications' identity and appearance. As with environment 150 (described with respect to FIG. 2) the final mobile application built for a specific mobile platform may be signed using one or more certificates of application builder 252 and made available to users by virtue of the appropriate mobile application marketplace. Users of system 200 are able to create uniquely branded applications themselves and distribute such applications through their preferred channels without having to deal with the development, quality and maintenance assurance of the application.

FIG. 3B is a diagrammatic view of a build director generating a mobile application in accordance with an embodiment described herein. As shown in FIG. 3B, build director 254 receives custom information 257 and application configuration information 162 and runs or otherwise controls an application building process in accordance with one embodiment. First, build director 254 will update a project file or wrapper using the supplied custom information 257 and application configuration information. The updated project file or wrapper is used by build director 254 to build an individual application targeted for a particular platform, as indicated at reference numeral 262. Build director may perform project update 260 for each targeted mobile platform, with each such project update 260 being followed by an application building process 262. The built applications are then signed and made available for use as indicated at block 264. Making the applications available for use can be performed by supplying each application to its respective mobile application marketplace. The result is a unique mobile application with a visual customization as indicated at block 266.

FIG. 3C is a diagrammatic view of customization information for mobile application builds in accordance with an embodiment described herein. Customization information 257 includes identification information 258. In the example shown in FIG. 3C, the identification of the mobile application is changed based on the target mobile application platform. For example, the designation “C5” must be capitalized for the Google Play Store and the Microsoft Windows Store, while the Apple Store requires the designation to be lowercase. This is merely one example of an application identity being customized based on the mobile platform upon which the application will be deployed. Branding information 260 and other platform specific display information 261 is stored, in one embodiment, in platform-specific containers, such as folders, 268, 270, 272, and 274. Thus, any suitable number of different mobile application platforms can be targeted for application deployment automatically, thereby allowing the application to behave the same on all such platforms, but to have different appearances and identity information, as desired.

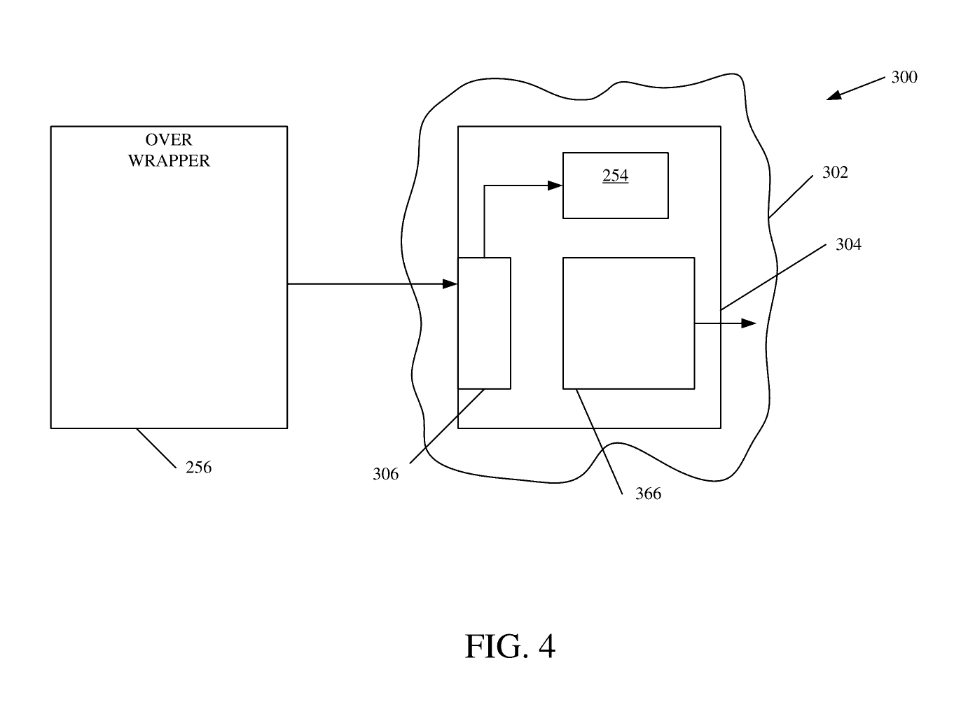

FIG. 4 is a diagrammatic view of another mobile application environment in which embodiments described herein can be practiced. Environment 300 includes cloud 302 that may be a public cloud, or a private cloud. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 200 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

Cloud-based application builder 304 is located within cloud 302 and includes an application programming interface 306 that is configured to receive an over wrapper, such as over wrapper 256. As described above with respect to FIG. 3, over wrapper 256 generally includes a project wrapper having web application source code as well as identity and branding information. Over wrapper 256 provides this information to application builder 304 via application programming interface 306. Application builder 304 includes build director 254, as a component thereof, which receives the over wrapper from application programming interface 306. Build director 254 interacts with build component 366 to automatically generate a plurality of mobile applications using the single web application source code (generally in the form of HTML, CSS, and JavaScript) as well as branding information 260 and identity information 258. Build component 366 generates the mobile application by including any suitable software resources and compiling or otherwise processing the web application source code. Upon completion, build component 366 will sign or otherwise certify the finished mobile application and provide the certified mobile application for consumption by a user. As set forth above, the provision of such finished mobile application can generally be provided by making the application available in the suitable mobile application marketplace for the targeted mobile platform. However, it is also contemplated that the finished mobile application may simply be returned to the user via cloud 302.

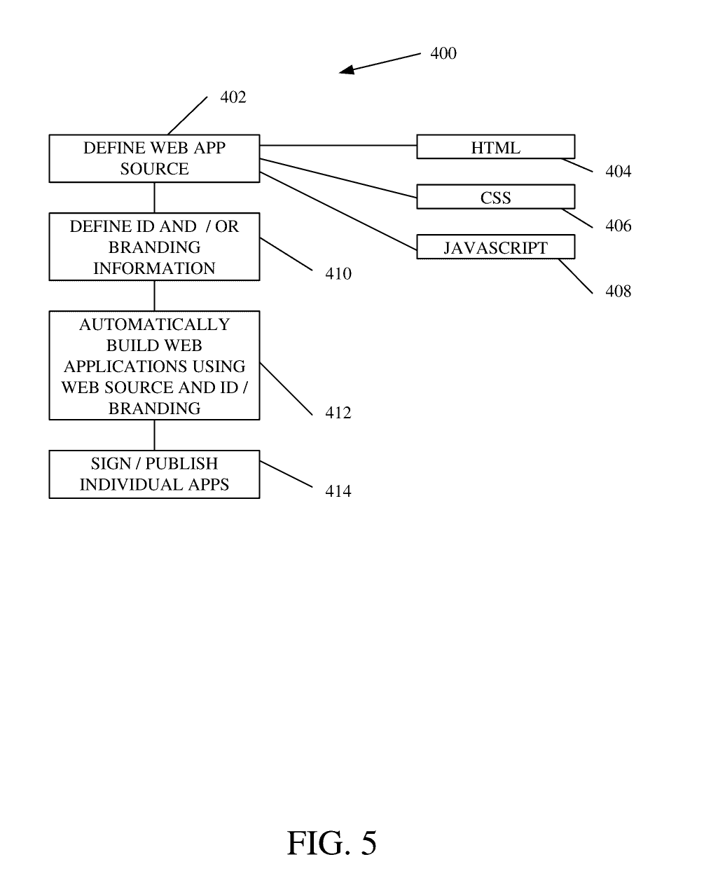

FIG. 5 is a flow diagram of a method for developing a mobile application in accordance with one embodiment. Method 400 begins at block 402 where a developer defines or otherwise provides web application source code. This web application source code is generally in the form of HTML 404, CSS 406, and JavaScript 408. Once the web application source code has been defined in block 402, method 400 passes to block 410 where identification and/or branding information is specified for the mobile applications. Such identification and branding information can include, in one embodiment, individual application names, descriptions, icons, images, and font resources. Next, at block 412, a build process is initiated to automatically build a plurality of web applications using the web application source code information defined at block 402 along with the identification and/or branding information provided at block 410. The result of this automatic build process is a plurality of mobile applications where each application is unique and can be distributed through its respective application marketplace with its own name, description, icons, images, and font resources. This is so even though each unique application is derived from a single functional code base specified at block 402. Finally, at block 414, the completed mobile applications are optionally signed and then published to the respective mobile application marketplaces for consumption by mobile application users.

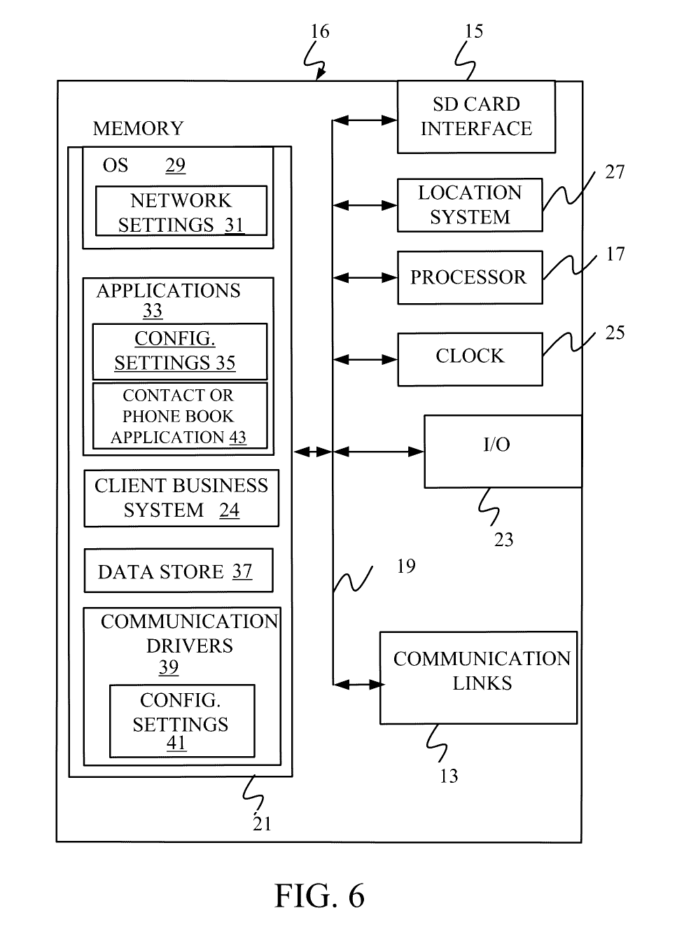

FIG. 6 provides a general block diagram of the components of a client mobile device 16 that interacts with architecture 100. In device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Device 16 can have a client business system 24 which can run various applications provided by execution framework 118 (shown in FIG. 1). Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well. Applications 33 can include applications that are built by a mobile application builder such as any of those described above. Applications 33 may be installed from an application marketplace that is suitable for device 16 based on its operating system 29. Moreover, applications 33 may be any suitable mobile applications. However, in one embodiment, applications 33 includes one or more applications that facilitate interaction with system 102 (described with respect to FIG. 1).

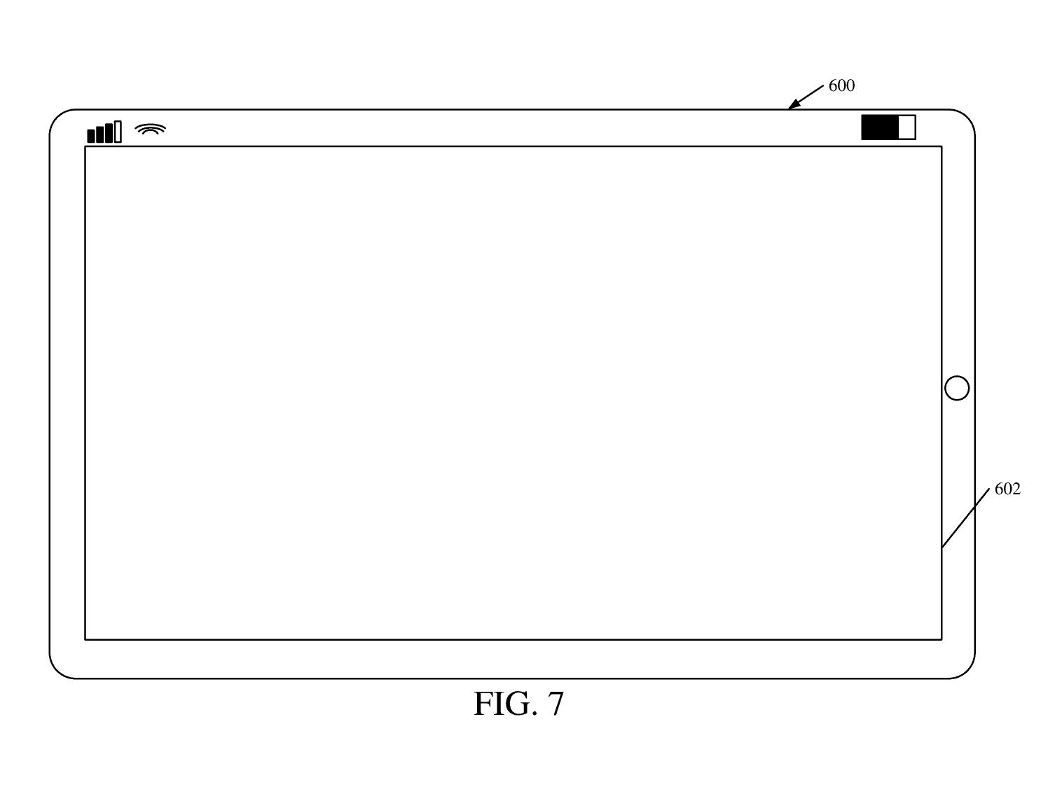

FIG. 7 shows one embodiment in which the mobile device is a tablet computer 600. In FIG. 7, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

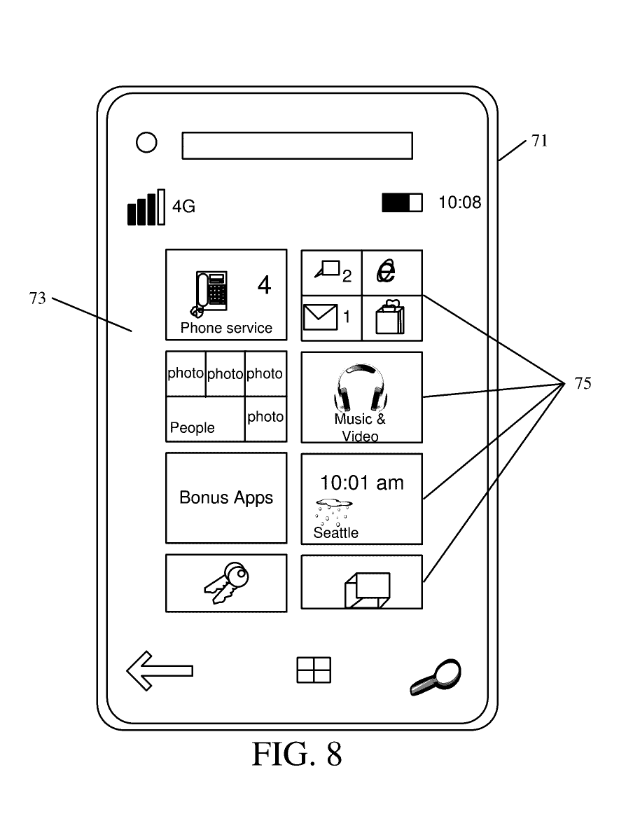

FIG. 8 provides an additional example of a mobile 16 that can be used, although others can be used as well. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

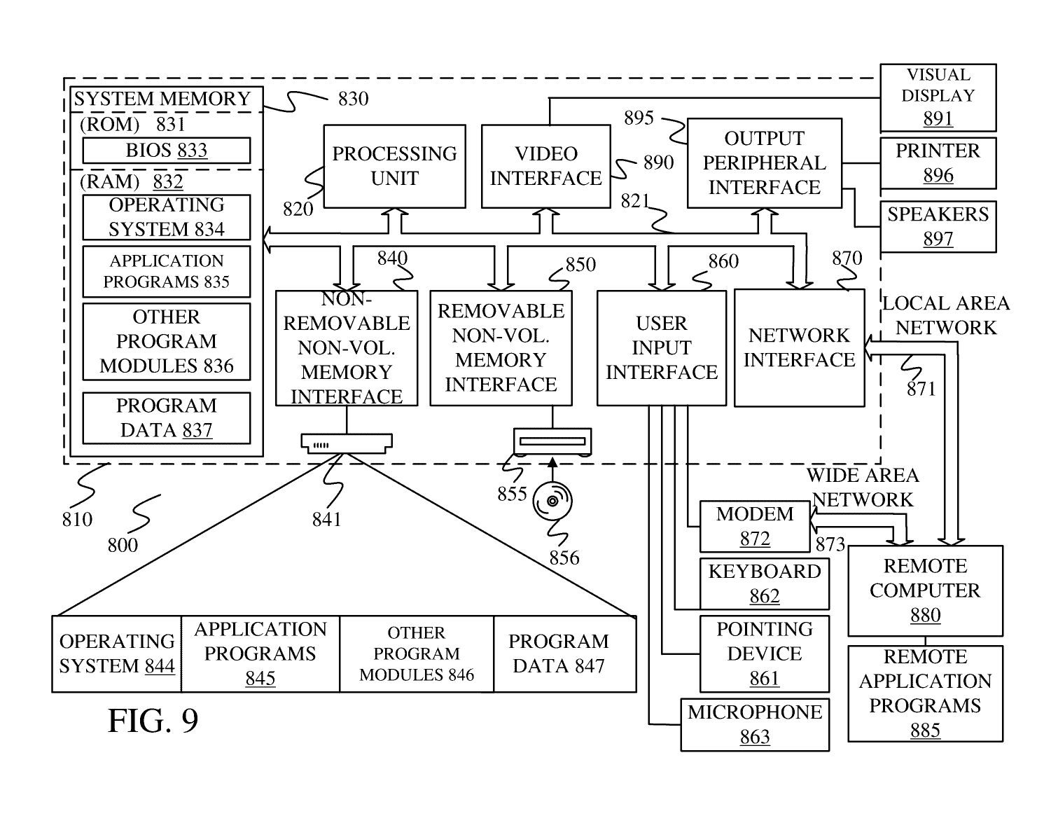

FIG. 9 illustrates one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 124, 186 or 190), system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a mobile application development system with a processor that is a functional component of the mobile application development system and that is configured to execute programmatic steps. A build component is configured to receive web application source code and generate a mobile web application for a targeted mobile application platform. A build director component is configured to receive the web application source code and customization information and direct the build component to generate a plurality of mobile web applications each targeting a different mobile application platform, using the same web application source code and the customization information.

Example 2 is the mobile application development system of any or all previous examples wherein the web application source code includes HTML content.

Example 3 is the mobile application development system of any or all previous examples wherein the web application source code includes CSS content.

Example 4 is the mobile application development system of any or all previous examples wherein the web application source code includes JavaScript content.

Example 5 is the mobile application development system of any or all previous examples wherein the customization information includes identity information.

Example 6 is the mobile application development system of any or all previous examples wherein the customization information includes branding information.

Example 7 is the mobile application development system of any or all previous examples wherein each respective mobile web application has different image files, but the same behavior.

Example 8 is the mobile application development system of any or all previous examples wherein each respective mobile web application has different branding information, but the same behavior.

Example 9 is the mobile application development system of any or all previous examples and further comprising a certification component that is configured to sign each mobile web application.

Example 10 is the mobile application development system of any or all previous examples and further comprising a publishing component configured to publish each mobile web application to its respective mobile application marketplace.

Example 11 is the mobile application development system of any or all previous examples wherein the customization information includes identity information and branding information provided in an over wrapper that encapsulates the web application source code.

Example 12 is the mobile application development system of any or all previous examples wherein the build director is a component of the mobile application development system.

Example 13 is the mobile application development system of any or all previous examples wherein the mobile application development system is cloud-based.

Example 14 is the mobile application development system of any or all previous examples and further comprising at least one application programming interface configured to receive an over wrapper containing web application source code, identity information and branding information.

Example 15 is a method of automatically generating mobile applications for a plurality of different mobile application platforms. The method includes exposing an application programming interface of a mobile application building system. Customization information is received through the application programming interface. A build process is run multiple times using the customization information to generate a plurality of mobile applications, each incorporating the customization information during the build process and targeting a different mobile application platform.

Example 16 is the method of any or all previous examples wherein each application is built using the same web application source code.

Example 17 is the method of any or all previous examples wherein the web application source code includes HTML, CSS, and JavaScript.

Example 18 is the method of any or all previous examples wherein the customization information includes branding information and web application source code that is provided to the application programming interface in an over wrapper.

Example 19 is the method of any or all previous examples and further comprising signing each mobile application and publishing each mobile application to its respective mobile application platform marketplace.

Example 20 is a cloud-based mobile application development system. The system includes a build component configured to generate a mobile web application targeted to a selected mobile application platform based on web application source code. An application programming interface is configured to receive web application source code and customization information. A build director is coupled to the application programming interface and the build component. The build director is configured to engage the build component to generate a plurality of mobile web applications targeting different selected mobile application platforms using the same web application source code and different customization information for each mobile web application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A mobile application development system comprising:
a processor that is a functional component of the mobile application development system and is configured to execute programmatic steps;
a build component that is configured to receive web application source code and generate a mobile web application for a target mobile application platform; and
a build director component configured to receive the web application source code and customization information that includes identity information and branding information provided in an over wrapper that encapsulates the web application source code and to direct the build component to generate a plurality of mobile web applications each targeting a different mobile application platform, using the same web application source code and the customization information.

2. The mobile application development system of claim 1, wherein the web application source code includes HTML content.

3. The mobile application development system of claim 2, wherein the web application source code includes cascading style sheet content.

4. The mobile application development system of claim 3, wherein the web application source code includes JavaScript content.

5. The mobile application development system of claim 1, wherein the customization information includes identity information.

6. The mobile application development system of claim 5, wherein the customization information includes branding information.

7. The mobile application development system of claim 6, wherein each respective mobile web application has different image files, but the same behavior.

8. The mobile application development system of claim 6, wherein each respective mobile web application has different branding information, but the same behavior.

9. The mobile application development system of claim 1, and further comprising a certification component that is configured to sign each mobile web application.

10. The mobile application development system of claim 1, and further comprising a publishing component configured to publish each mobile web application to its respective mobile application marketplace.

11. (canceled)

12. The mobile application development system of claim 1, wherein the build director is a component of the mobile application development system.

13. The mobile application development system of claim 1, wherein the mobile application development system is cloud-based.

14. The mobile application development system of claim 13, and further comprising at least one application programming interface configured to receive the over wrapper.

15. A method of automatically generating mobile applications for a plurality of different mobile application platforms, the method comprising:
exposing an application programming interface of a mobile application building system;
receiving an over wrapper containing web application source code, identity information and branding information through the application programming interface;
running a build process multiple times using the web application source code, identity information and branding information to generate a plurality of mobile applications, each incorporating the web application source code, identity information and branding information during the build process and targeting a different mobile application platform.

16. The method of claim 15, wherein each application is built using the same web application source code.

17. The method of claim 15, wherein the web application source code includes HTML, CSS, and JavaScript.

18. (canceled)

19. The method of claim 15, and further comprising signing each mobile application and publishing each mobile application to its respective mobile application platform marketplace.

20. A cloud-based mobile application development system comprising:
a processor that is a functional component of the mobile application development system and is configured to execute programmatic steps;
a build component configured to generate a mobile web application targeted to a selected mobile application platform based on web application source code;
an application programming interface configured to receive web application source code and customization information that includes identity information; and
a build director coupled to the application programming interface and the build component, the build director being configured to engage the build component to generate a plurality of mobile web applications targeting different selected mobile application platforms using the same web application source code and different customization information for each mobile web application.
